(19) United States
(12) Patent Application Publication
(10) Pub. No.: US 2008/0316199 A1
(43) Pub. Date: Dec. 25, 2008

(54) CIRCUIT SYSTEM FOR READING MEMORY DATA FOR DISPLAY DEVICE

(76) Inventor: Jung-Ping Yang, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/963,855

(22) Filed: Dec. 24, 2007

(30) Foreign Application Priority Data
Jun. 25, 2007 (TW) 096122903

(51) Int. Cl. G06F 3/038

(52) U.S. Cl. 345/214

(57) ABSTRACT

To reduce power consumption and enhance memory-data transmission efficiency, the present invention provides a circuit system for reading memory data for a display device includes a memory, a data bus and a latch circuit. The memory is used for storing pixel data corresponding to a plurality of pixels and outputting the pixel data according to an output control signal. The data bus is used for transferring the pixel data outputted by the memory. The latch circuit is coupled to the data bus and used for receiving the pixel data from the data bus. The latch circuit includes a plurality of latchers and a plurality of logic circuits. The plurality of latchers is used for storing the pixel data. The plurality of logic circuits is used for performing logic operations on the pixel data stored in the plurality of latchers according to a reading control signal.

### BACKGROUND OF THE INVENTION

1. Field of the Invention

The present invention relates to a reading circuit system, and more particularly to a circuit system for reading memory data for a display device that can reduce power consumption and enhance transmission efficiency.

2. Description of the Prior Art

A liquid crystal display (LCD) is a flat panel display, and has advantages of low radiation, light weight and low power consumption. Thus, the LCD is widely used in various information technology (IT) products, such as a notebook computer, a personal digital assistant (PDA), and a mobile phone. Operating principle of the LCD is converting digital image data, such as RGB data, into analog voltage signals and using the voltage signals to drive liquid crystals so as to change twisted angles of the liquid crystals. As a result, different colors can be displayed on each pixel and thereby the image is shown on a panel of the LCD.

As well known in the art, a typical LCD utilizes a controlling and driving circuit to convert the image data into voltage signals. Please refer to FIG. 1, which is a schematic diagram of a controlling and driving circuit 10 for an LCD according to the prior art. The controlling and driving circuit 10 includes a memory 100, a timing controller 110, a shift register 112, a line latch 114, a level shifter 116, a digital-to-analog converter (DAC) 118 and a source driver 120. The memory 100 stores image data, and outputs the image data to the timing control device 110 through a data bus DB1. In general, the LCD displays a frame line-by-line. Thus, the memory 100 outputs image data of a line, called line display data hereinafter, each time. The timing controller 110 can perform logic operations on the line display data and then transmits the line display data to the shift register 112 via a data bus DB2. The logic operations could be grayscale adjustment, such as conversion from white to black or from black to white. The shift register 112 stores the line display data bit-by-bit, and transmits the entire line display data to the line latch 114 at a time. The line latch 114 latches the line display data and the level shifter 116 adjusts signal levels of the line display data. The DAC 118 converts the line display data into analog voltage signals, and at last the source driver 120 outputs the voltage signals to corresponding pixels of the panel.

The timing controller 110 of the prior art needs to perform image-processing operations and also controls access timing and order of the memory 100 and the shift register 112. Thus, the problems of high complexity and large chip area need to be dealt with in the hardware practice of the timing control device 110. In addition, the image data stored in the memory 100 is passed through both the data bus DB1 and the data bus DB2 during transmission to the timing control device 110 and the shift register 112. Accessing the data buses two times cause more power consumption. For a large-size LCD, the timing control device 110 is required to handle plenty of data at a time. Therefore, it is an objective to design a data reading system having low power consumption and high transmission efficiency.

### SUMMARY OF THE INVENTION

The present invention provides a circuit system for reading memory data for a display device that can reduce power consumption and enhance transmission efficiency.

The present invention discloses a circuit system for reading memory data for a display device. The circuit system comprises a memory, a data bus and a latch circuit. The memory is used for storing pixel data corresponding to a plurality of pixels and outputting the pixel data according to an output control signal. The data bus is coupled to the memory and used for transferring the pixel data outputted from the memory. The latch circuit is coupled to the data bus and used for receiving the pixel data transferred by the data bus. The latch circuit comprises a plurality of latchers and a plurality of logic circuits. The plurality of latchers is used for storing the pixel data transferred by the data bus. The plurality of logic circuits is coupled to the plurality of latchers and used for performing logic operations for the pixel data stored in the plurality of latchers according to a reading control signal. A timing control device is used for generating the output control signal and the reading control signal.

The present invention further discloses a circuit system for reading memory data for a display device. The circuit system comprises a memory and a latch circuit. The memory comprises at least a memory bank each comprising an internal data bus. The at least a memory bank is used for storing pixel data corresponding to a plurality of pixels and outputting the pixel data via corresponding internal data buses according to an output control signal. The latch circuit is coupled to the memory and used for receiving the pixel data outputted by the memory according to a reading control signal. A timing control device is used for generating the output control signal and the reading control signal.

The present invention further discloses a circuit system for reading memory data for a display device. The circuit system comprises a plurality of memory banks, a plurality of data bus units and a latch circuit. Each memory bank is used for storing pixel data corresponding to a plurality of pixels and outputting the pixel data according to an output control signal. The plurality of data bus units is cascaded in a sequence and used for transferring the pixel data outputted by the plurality of memory banks. Each data bus unit comprises a segmented bus coupled to one of the plurality of memory banks, for transferring the pixel data outputted by the coupled memory bank, and a transmission gate coupled between the segmented bus and another one of the plural data bus units, for conducting or cutting off a link between the segmented bus and the coupled data bus unit according to a switching signal. The latch circuit is coupled to the plurality of data bus units and used for receiving the pixel data outputted by the plurality of data bus units according to a reading control signal. A timing control device is used for generating the output control signal, the switching signal and the reading control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a controlling and driving circuit for an LCD according to the prior art.

FIG. 2 is a schematic diagram of a controlling and driving circuit for a display device according to an embodiment of the present invention.

FIGS. 3-6 are schematic diagrams of circuit systems according to embodiments of the present invention.

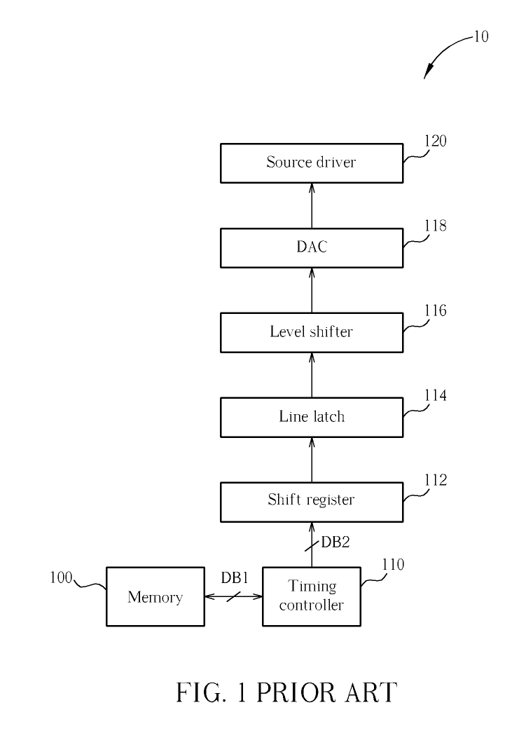

### DETAILED DESCRIPTION

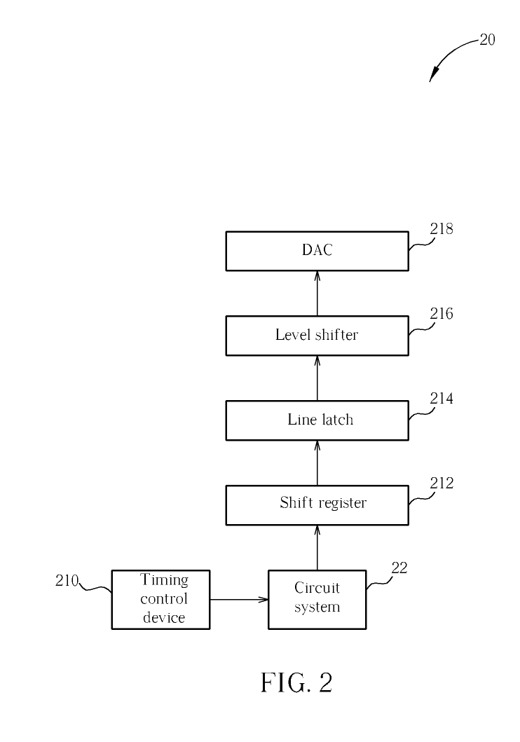

Please refer to FIG. 2, which is a schematic diagram of a controlling and driving circuit 20 for a display device according to an embodiment of the present invention. The controlling and driving circuit 20 is utilized to convert image data stored in a memory into voltage signals and outputs the voltage signals to pixels on a panel of the display device. The controlling and driving circuit 20 includes a circuit system 22, a timing control device 210, a line latch 212, a level shifter 214, a digital-to-analog converter (DAC) 216 and a source driver 218. The circuit system 22 is utilized to read memory data and outputs the read memory data to the line latch 212 for latching line display data. The timing control device 210 can control the circuit system 22 with control and setting signals, such as timing, order, location and quantity of memory data reading. The line latch 212, the level shifter 214, the DAC 216 and the source driver 218 are identical with the controlling and driving circuit 10, and operating principles thereof are omitted herein.

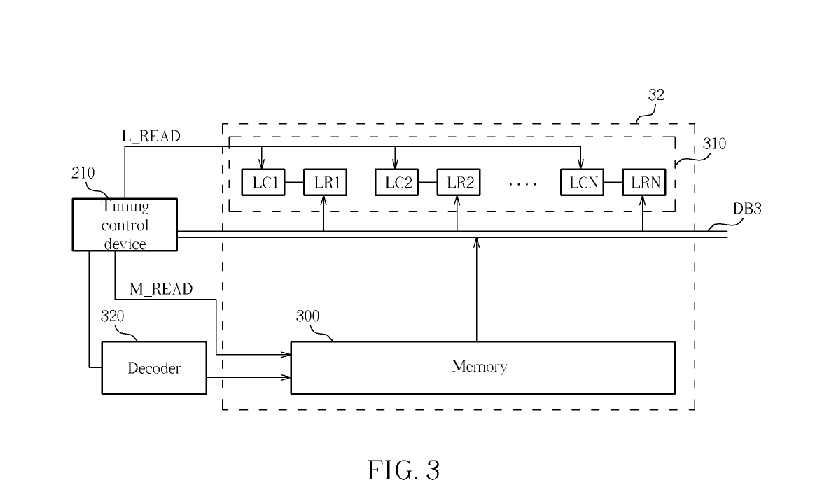

Please refer to FIG. 3, which is a schematic diagram of a circuit system 32 according to an embodiment of the present invention. The circuit system 32 is utilized to realize the circuit system 22, and includes a memory 300, a data bus DB3 and a latch circuit 310. The memory 300 stores pixel data corresponding to a plurality of pixels and outputting the pixel data according to an output control signal M_READ generated by the timing control device 210. Preferably, the memory 300 outputs data corresponding to pixels of a line of display frame, called line display data hereinafter, and the data bus DB3 transfers the line display data outputted from the memory 300. The latch circuit 310 receives the line display data transferred by the data bus DB3, and includes latchers LR1-LRN and the logic circuits LC1-LCN. As shown in FIG. 3, the latchers LR1-LRN and the logic circuits LC1-LCN couple one-to-one. The latchers LR1-LRN stores the line display data transferred by the data bus DB3. In the embodiment, the latcher number is the same as the number of pixels of a line, and each latcher stores data of a pixel. Thus, the latchers LR1-LRN can exactly store data for a line. According to a reading control signal L_READ generated by the timing control device 210, the logic circuits LC1-LCN respectively perform logic operations on the display data stored in the latchers LR1-LRN. The logic operations could be grayscale adjustment, such as conversion from white to black or from black to white. As can be seen from the above, the memory 300 parallel transmits each pixel data of the line display data to the latch circuit 310 via the data bus DB3. Therefore, in the embodiment, the bus is accessed only one time during the transmission of the line display data from the memory 300 to the line latch 212. In addition, the latch circuit 310 can perform the logic operations so that complexity and chip area of the timing control device 210 can be reduced.

In practice, since sizes of the memory 300 and the latch circuit 310 are different, the line display data may be defined in different allocations in the memory 300 and the latch circuit 310. In order for the line display data to be read out from the memory 300 correctly and to be stored in the latch circuit 310 correctly, the timing control device 210 outputs initial address information corresponding to the line display data to the latch circuit 310, and also outputs remapped address information corresponding to the initial address information to the memory 300. The latch circuit 310 decodes the initial address information to obtain which pixel data corresponding to the data stored in the latchers LR1-LRN is. The memory 300 utilizes a decoder 320 to decode the remapped address information.

For example, the latch circuit 310 includes 640 latchers, and the memory 300 includes a 600×512 memory array. The image size of the display device is 640×480 (column×row), and the display device displays images line-by-line. As a result, the memory 300 stores image data line-by-line. For the line display data of the first line of an image, the memory 300 stores 600 pixel data in the first row of the memory 300 and stores the rest of 40 pixel data of the line display data in the first 40 memory cells in the second row of the memory 300. When the line display data of the first line is outputted to the panel, the memory 300 obtain an output range information, which are pointed to the abovementioned stored pixel data, according the to remapped address information received from the timing control device 210. According to the first address information, the latch circuit 310 controls the latchers LR1-LRN to store the line display data from the memory 300, one latcher to one pixel. For example, the latcher LR1 stores the pixel data outputted from the first memory cell of the first row of the memory 300, while the latcher LRN stores the pixel data outputted from the 40th memory cell of the second row. As from the above, the remapped and initial address information is utilized to transform two-dimensional array data into one-dimensional array data.

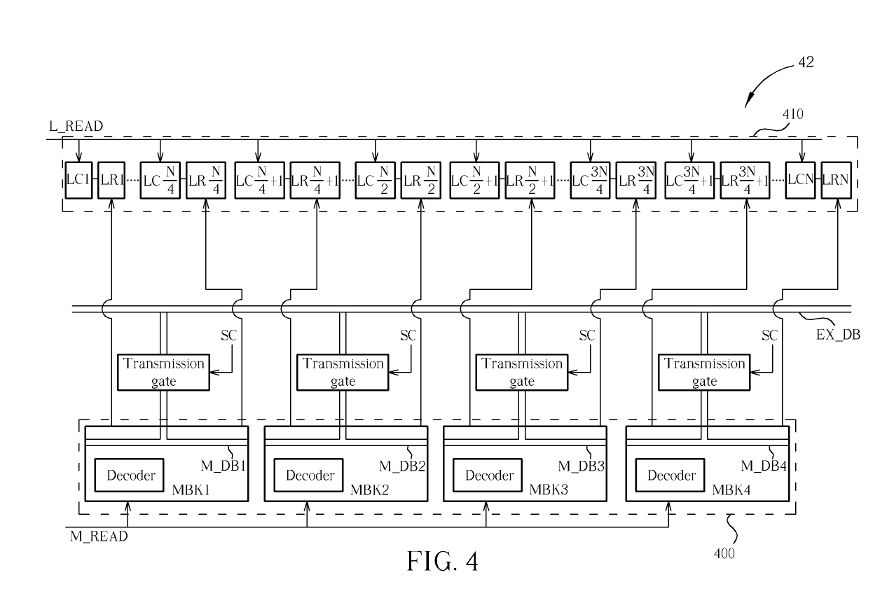

Please refer to FIG. 4, which is schematic diagram of a circuit system 42 according to another embodiment of the present invention. The circuit system 42 is utilized to realize the circuit system 22, and includes a memory 400 and a latch circuit 410. The memory 400 includes the memory banks MBK1-MBK4, which includes internal data buses M_DB1-M_DB4. The memory banks MBK1-MBK4 store pixel data corresponding to a plurality of pixels and output the pixel data via the internal data buses M_DB1-M_DB4 according to an output control signal M_READ outputted by the timing control device 210. In the embodiment, the abovementioned line display data can be segmented to be stored in the memory banks MBK1-MBK4. Similar to the latch circuit 310, the latch circuit 410 receives the line display data outputted from the memory 400 according to a reading control signal L_READ outputted form the timing control device 210 and includes the latchers LR1-LRN and the logic circuits LC1-LCN. As shown in FIG. 4, the latchers LR1-LR(N/4), LR(N/4+1)-LR(N/2), LR(N/2+1)-LR(3N/4) and LR(3N/4+1)-LRN store data outputted from the internal data buses M_DB1-M_DB4, respectively. Preferably, the latchers LR1-LRN and pixel related to the line display data have a one-to-one relationship. The logic circuits LC1-LCN perform logic operations on the line display data stored in the latchers LR1-LRN, and then the line display data is outputted to the line latch 212. In the circuit system 42, the line display data is segmented and thereby the segments are stored in the memory banks M_DB1-M_DB4, respectively. The internal data buses M_DB1-M_DB4 outputs the segments to the latch circuit parallel. Therefore, the embodiment of the present invention utilizes the internal data buses to transfer data to the latch circuit directly, reducing power consumption of data transmissions.

In the circuit system 42, the internal data buses M_DB1-M_DB4 may couple to an external data bus EX_DB so as to transfer the line display data to peripheral devices. In this situation, transmission gates are installed between the internal data buses M_DB1-M_DB4 and the external data bus. During the period the memory banks MBK1-MBK4 outputting the line display data to the latch circuit 410, the transmission gates cut off the link between the internal data buses M_DB1-M_DB4 and the external data bus to prevent the line display data from being received by the external data bus. If the external data bus needs to transfer the line display data, the transmission gates conduct the link. The external data bus is commonly controlled by the timing control device 210. Furthermore, to access the line display data correctly, the timing control device 210 outputs initial address information corresponding to the line display data to the latch circuit 410, and also outputs remapped address information corresponding to the initial address information to the memory banks MBK1-MBK4. The latch circuit 410 decodes the initial address information to obtain which pixel data the latchers LR1-LRN should store. Each of the memory banks MBK1-MBK4 includes a decoder for decoding the remapped address information to obtain corresponding storing locations of the line display data.

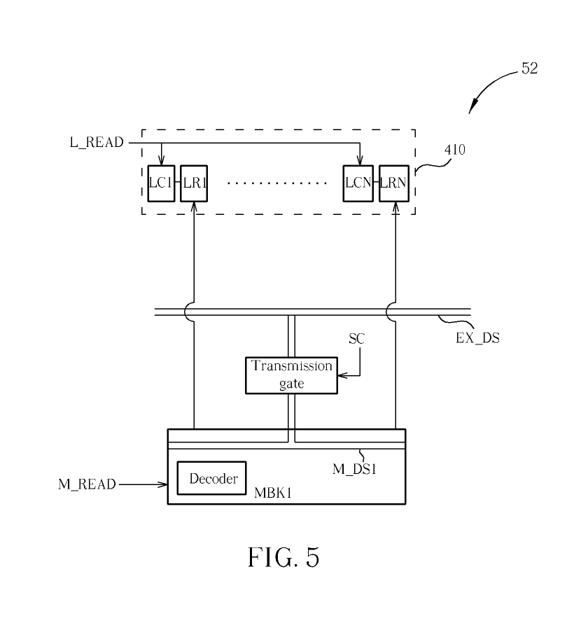

Please note that those skilled in the art can determine the number of the memory banks according to capacity of the memory banks and data bits used for each pixel. The above embodiments are used for concise explanation of the present invention concept, and the number of the memory banks is not limited to be four. The couplings between the internal data buses and the latchers are also an example of the present invention. The number of the latchers which every internal data bus couples to can be adjusted if necessary. If the line display data is less enough and a bandwidth of the internal data bus is great enough, the circuit system 42 can employ only one memory bank. Please refer to FIG. 5, which is a schematic diagram of a circuit system 52 employing a memory bank in a basis of the circuit system 42. As seen from FIG. 5, the internal data bus M_DB1 couples to the latchers LR1-LRN. As a result, the memory bank MBK1 output the entire line display data to the latch circuit 410 at a time.

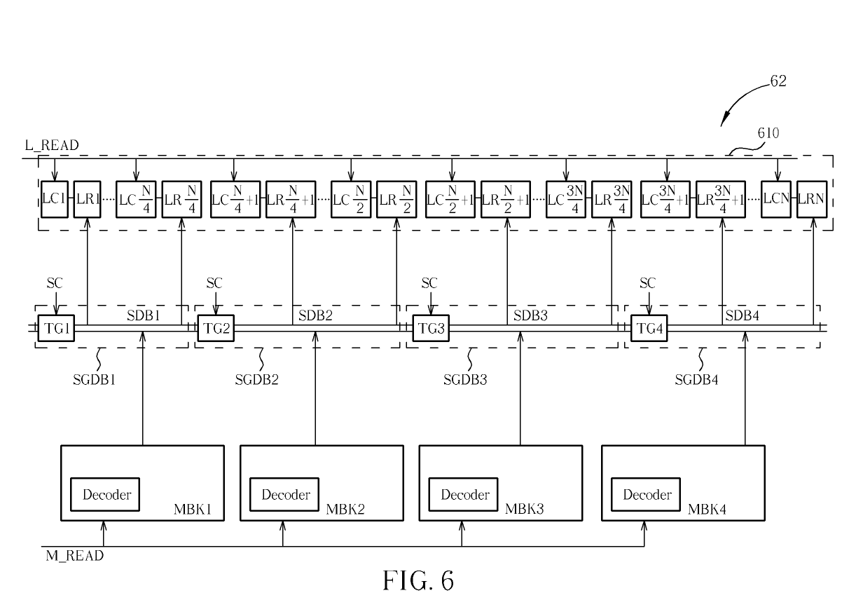

Please refer to FIG. 6, which is a schematic diagram of a circuit system 62 according to another embodiment of the present invention. The circuit system 62 is utilized to realize the circuit system 22, and includes memory banks MBK1-MBK4, data bus units SGDB1-SGDB4 and a latch circuit 610. The memory banks MBK1-MBK4 store pixel data corresponding to a plurality of pixels and output the pixel data according to an output control signal M_READ outputted by the timing control device 210. In the embodiment, the abovementioned line display data can be segmented to be stored in the memory banks MBK1-MBK4. As shown in FIG. 6, the data bus units SGDB1-SGDB4 are cascaded and transfer the line display data outputted by the memory banks MBK1-MBK4. The data bus units SGDB1-SGDB4 include segmented buses SDB1-SDB4 and transmission gates TG1-TG4, respectively. The segmented buses SDB1-SDB4 connect to the memory banks MBK1-MBK4 respectively and transfer the line display data outputted by the memory banks MBK1-MBK4. Each transmission gate conducts or cuts off a link between two consecutive data bus units according to a switching signal SC. For example, the transmission gate TG2 is coupled between the segmented buses SDB1 and SDB2. If the data bus unit SGDB1 or SGDB2 would like to share data, the transmission gate TG2 conducts the link. If the data bus units SGDB1 and SGDB2 need to operate independently, the transmission gate TG2 cuts off the link so that data transmissions of the data bus units SGDB1 and SGDB2 are isolated from each other. In addition, the links conducted by the transmission gates TG2-TG4 allow the memory bank MBK2 to communicate with peripheral devices including the timing control device 210.

Like the latch circuit 410, the latch circuit 610 includes the latchers LR1-LRN and the logic circuits LC1-LCN, and is used for receiving the line display data transferred by the data bus units SGDB1-SGDB4 according to a reading control signal L_READ. The latchers LR1-LR(N/4), LR(N/4+1)-LR(N/2), LR(N/2+1)-LR(3N/4) and LR(3N/4+1)-LRN store data outputted by the segmented buses SDB1-SDB4, respectively. The logic circuits LC1-LCN2 perform logic operations on the data stored in the latchers LR1-LRN. Preferably, each the latcher stores data of a pixel. With the latchers LR1-LRN, the latch circuit 610 can receive every segment of the line display data. Similar to the above, the timing control device 210 outputs initial address information corresponding to the line display data to the latch circuit 610 and also remapped address information corresponding to the initial address information to the memory banks MBK1-MBK4. The latch circuit 610 decodes the initial address information to obtain which pixel data each of the latchers LR1-LRN should store. Each of the memory banks MBK1-MBK4 includes a decoder for decoding the remapped address information to obtain the targeting latchers where the line display data should be stored. In the circuit system 62, with cascaded, independent and segmented data buses, the embodiment can simultaneously transfer multiple data sources from the memory banks. As a result, data buses having a narrower bandwidth can be employed in the embodiment, reducing the production cost and increasing the transmission efficiency.

Please note that the number of the memory banks is not limited to be four in the circuit system 62. The concept of the embodiment is usage of the cascaded, independent and segmented data buses. The coupling arrangement of each segmented data bus and the latchers are an example, and those skilled in the art can modify the arrangement to fit their needs. Besides, the switching signal SC is shared by the transmission gates TG1-TG4 in the abovementioned embodiments. For some display devices, the switching signals for each transmission gate can be generated individually so that the conduction or cut-off of the links is independently controlled.

In summary, in the prior art, pixel data outputted by the memory undergoes the image processes of the timing controller and is then outputted through the shift register, to the line latch. During the process, there is a need of accessing the pixel data from the data bus twice. Thus, the transmission of the pixel data from the memory to the line latch consumes more power, and the timing controller requires higher complexity and chip area. In the embodiments of the present invention, the latch circuit can replace the shift register of the prior art and includes image-processing functions used in the timing controller of the prior art. As a result, the pixel data needs to be accessed one time to the data bus. In FIG. 4 and 5, the internal data bus is employed to transfer the pixel data directly from the memory to the latch circuit, reducing data load and power consumption of the external data bus. In FIG. 6, cascaded, independent and segmented data buses are employed to transfer the pixel data, considering that the external data bus is segmented. Data outputs of the memory banks can be parallel and independent to each other. Therefore, the embodiments of the present invention increase controlling flexibility and only require low-bandwidth data buses.

Those skilled in the art will readily observe that numerous modifications and alterations of the device and method may be made while retaining the teachings of the invention.

What is claimed is:

1. A circuit system for reading memory data for a display device comprising:
a memory for storing pixel data corresponding to a plurality of pixels and outputting the pixel data according to an output control signal;
a data bus coupled to the memory, for transferring the pixel data outputted from the memory; and
a latch circuit coupled to the data bus, for receiving the pixel data transferred by the data bus, the latch circuit comprising:
a plurality of latchers for storing the pixel data transferred by the data bus; and
a plurality of logic circuits coupled to the plurality of latchers, for performing logic operations for the pixel data stored in the plurality of latchers according to a reading control signal.

2. The circuit system of claim 1 further comprising a timing control device used for generating the output control signal and the reading control signal.

3. The circuit system of claim 1, wherein the latch circuit decodes first address information corresponding to the pixel data received by the latch circuit.

4. The circuit system of claim 3, wherein the first address information corresponds to remapped address information.

5. The circuit system of claim 4 further comprising a decoder coupled to the memory, for outputting the remapped address information to the memory after decoding the remapped address information.

6. The circuit system of claim 1 further comprising a line latch coupled to the latch circuit, for receiving data outputted by the latch circuit.

7. A circuit system for reading memory data for a display device comprising:
a memory comprising at least a memory bank, each memory bank comprising an internal data bus, the memory bank used for storing pixel data corresponding to a plurality of pixels and outputting the pixel data via the corresponding internal data bus according to an output control signal; and
a latch circuit coupled to the memory, for receiving the pixel data outputted by the memory according to a reading control signal.

8. The circuit system of claim 7 further comprising a timing control device used for generating the output control signal and the reading control signal.

9. The circuit system of claim 7, wherein the latch circuit comprises:
a plurality of latchers for storing pixel data outputted by the memory; and
a plurality of logic circuits coupled to the plurality of latchers, for performing logic operations on the pixel data stored in the plurality of latchers.

10. The circuit system of claim 7 further comprising at least a transmission gate for cutting off or conducting a link between the internal data bus of the memory and an external data bus.

11. The circuit system of claim 7, wherein the latch circuit decodes first address information corresponding to the pixel data received by the latch circuit.

12. The circuit system of claim 11, wherein the first address information corresponds to remapped address information.

13. The circuit system of claim 12, wherein each of the memory bank further comprises a decoder for decoding the remapped address information.

14. The circuit system of claim 7 further comprising a line latch coupled to the latch circuit, for receiving data outputted from the latch circuit.

15. A circuit system for reading memory data for a display device comprising:
a plurality of memory banks, each memory bank used for storing pixel data corresponding to a plurality of pixels and outputting the pixel data according to an output control signal;
a plurality of data bus units cascaded in a sequence, for transferring the pixel data outputted by the plurality of memory banks, each data bus unit comprising:
a segmented bus coupled to one of the plurality of memory banks, for transferring the pixel data outputted by the coupled memory bank; and
a transmission gate coupled between the segmented bus and another one of the plural data bus units, for conducting or cutting off a link between the segmented bus and the coupled data bus unit according to a switching signal; and
a latch circuit coupled to the plurality of data bus units, for receiving the pixel data outputted by the plurality of data bus units according to a reading control signal.

16. The circuit system of claim 15 further comprising a timing control device for generating the output control signal, the switching signal and the reading control signal.

17. The circuit system of claim 15, wherein the latch circuit comprises:
a plurality of latchers for storing the pixel data transferred by the plurality of data bus units; and
a plurality of logic circuits coupled to the plurality of latchers, for performing logic operations on the pixel data stored in the plurality of latchers.

18. The circuit system of claim 15, wherein the transmission gates of each data bus unit cut off the link between the segmented bus and the coupled data bus unit during the period of the segmented bus transferring the pixel data.

19. The circuit system of claim 15, wherein the latch circuit decodes first address information corresponding to the pixel data received by the latch circuit.

20. The circuit system of claim 19, wherein the first address information corresponds to remapped address information.

21. The circuit system of claim 20, wherein each of the plurality of memory banks further comprises a decoder for decoding the remapped address information.

22. The circuit system of claim 15 further comprising a line latch coupled to the latch circuit, for receiving data outputted from the latch circuit.

23. A circuit system for reading memory data for a display device comprising:
a timing control device for generating an output control signal and a reading control signal;
a memory coupled to the timing control device, for storing pixel data corresponding to a plurality of pixels and outputting the pixel data according to the output control signal;
a data bus coupled to the memory, for transferring the pixel data outputted from the memory; and
a latch circuit coupled to the data bus and the timing control device, for receiving the pixel data transferred by the data bus, the latch circuit comprising:
a plurality of latchers for storing the pixel data transferred by the data bus; and
a plurality of logic circuits coupled to the plurality of latchers, for performing logic operations for the pixel data stored in the plurality of latchers according to the reading control signal.

24. The circuit system of claim 23, wherein the latch circuit decodes first address information corresponding to the pixel data received by the latch circuit.

25. The circuit system of claim 23, wherein the first address information corresponds to remapped address information.

26. The circuit system of claim 25 further comprising a decoder coupled to the memory, for outputting the remapped address information to the memory after decoding the remapped address information.

27. The circuit system of claim 23 further comprising a line latch coupled to the latch circuit, for receiving data outputted by the latch circuit.

28. A circuit system for reading memory data for a display device comprising:
a timing control device used for generating an output control signal and a reading control signal;
a memory coupled to the timing control device, the memory comprising at least a memory bank, each memory bank comprising an internal data bus, the memory bank used for storing pixel data corresponding to a plurality of pixels and outputting the pixel data via the corresponding internal data bus according to the output control signal; and
a latch circuit coupled to the memory and the timing control device, for receiving the pixel data outputted by the memory according to the reading control signal.

29. The circuit system of claim 28, wherein the latch circuit comprises:
a plurality of latchers for storing pixel data outputted by the memory; and
a plurality of logic circuits coupled to the plurality of latchers, for performing logic operations on the pixel data stored in the plurality of latchers.

30. The circuit system of claim 28 further comprising at least a transmission gate for cutting off or conducting a link between the internal data buses of the memory and an external data bus.

31. The circuit system of claim 28, wherein the latch circuit decodes first address information corresponding to the pixel data received by the latch circuit.

32. The circuit system of claim 31, wherein the first address information corresponds to remapped address information.

33. The circuit system of claim 32, wherein each of the memory bank further comprises a decoder for decoding the remapped address information.

34. The circuit system of claim 28 further comprising a line latch coupled to the latch circuit, for receiving data outputted from the latch circuit.

35. A circuit system for reading memory data for a display device comprising:
a timing control device for generating an output control signal, a switching signal and a reading control signal.
a plurality of memory banks coupled to the timing control device, each memory bank used for storing pixel data corresponding to a plurality of pixels and outputting the pixel data according to the output control signal;
a plurality of data bus units cascaded in a sequence, for transferring the pixel data outputted by the plurality of memory banks, each data bus unit comprising:
a segmented bus coupled to one of the plurality of memory banks, for transferring the pixel data outputted by the coupled memory bank; and
a transmission gate coupled between the segmented bus and another one of the plural data bus units, for conducting or cutting off a link between the segmented bus and the coupled data bus unit according to the switching signal; and
a latch circuit coupled to the plurality of data bus units and the timing control device, for receiving the pixel data outputted by the plurality of data bus units according to the reading control signal.

36. The circuit system of claim 35, wherein the latch circuit comprises:
a plurality of latchers for storing the pixel data transferred by the plurality of data bus units; and
a plurality of logic circuits coupled to the plurality of latchers, for performing logic operations on the pixel data stored in the plurality of latchers.

37. The circuit system of claim 35, wherein the transmission gates of each data bus unit cut off the link between the segmented bus and the coupled data bus unit during the period of the segmented bus transferring the pixel data.

38. The circuit system of claim 35, wherein the latch circuit decodes first address information corresponding to the pixel data received by the latch circuit.

39. The circuit system of claim 38, wherein the first address information corresponds to remapped address information.

40. The circuit system of claim 39, wherein each of the plurality of memory banks further comprises a decoder for decoding the remapped address information.

41. The circuit system of claim 35 further comprising a line latch coupled to the latch circuit, for receiving data outputted from the latch circuit.
